(19) United States
(12) Patent Application Publication
(10) Pub. No.: US 2013/0273763 A1
(43) Pub. Date: Oct. 17, 2013

(54) DETACHABLE CONNECTOR

(71) Applicants: Gang Yu, Shenzhen (CN); Guofu Tang, Shenzhen (CN)

(72) Inventors: Gang Yu, Shenzhen (CN); Guofu Tang, Shenzhen (CN)

(21) Appl. No.: 13/520,547

(22) PCT Filed: Apr. 12, 2012
(86) PCT No.: PCT/CN12/73856

§ 371 Date: Jul. 3, 2012

(51) Int. Cl. H01R 13/639

(52) U.S. Cl. 439/345

(57) ABSTRACT

An easily detachable connector comprises a female connector and a male connector. The female connector has a wall body and a sleeve opening enclosed by the wall body. A through hole is disposed on the wall body. The male connector comprises a protruding body corresponding to the sleeve opening. The protruding body comprises a protruding piece disposed in a position corresponding to that of the through hole. When the connector is connected, the protruding body is inserted inside the sleeve opening and the protruding piece is fitted inside the through hole.

### FIELD OF THE INVENTION

The present invention relates to a connector and more particularly to a connector which has a female connector and a male connector which can be connected with each other securely and can be easily detached.

### BACKGROUND OF THE INVENTION

Under the rapid development of electronic industry, various electronic devices are introduced into the market. Users can enjoy the convenience brought by electronic devices in various application fields. Connector is commonly used in the electronic industry as an electronic fitting and is an important component. Connectors refer to all the connecting components and auxiliary accessories used in electronic signals and power source, and are a bridge between all the signals.

Therefore, it is important in the electronic industry to develop a connector which can be securely connected and is not easily detached.

Please refer to FIG. 1 is an illustration of a conventional connector and FIG. 2 is a sectional view of FIG. 1 along line A-A′.

As shown in FIGS. 1 and 2, a conventional connector 2 comprises a female connector 20 and a male connector 21. In order that the male connector 21 can be connected with the female connector 20 securely and will not detach, the male connector 21 and the female connector 20 are shrink fitted with each other. When the male connector 21 is inserted into the female connector 20, an outer wall of the male connector 21 is closely fitted on an inner wall of the female connector 20. Even though the male connector 21 and the female connector 20 can be closely fitted together, the male connector 21 can not be easily detached from the female connector 20. It is even more difficult to detach the male connector 21 from the female connector 20 when the connector 2 is small in size.

### SUMMARY OF THE INVENTION

The present invention provides a connector which has a female connector and a male connector which can be connected with each other securely and can be easily detached.

The present invention provides an easily detachable connector. The connector comprises a female connector and a male connector. The female connector has a wall body and a sleeve opening enclosed by the wall body. A through hole is disposed on the wall body. The male connector comprises a protruding body corresponding to the sleeve opening. The protruding body comprises a protruding piece disposed on a position corresponding to that of the through hole. When the connector is connected, the protruding body is inserted inside the sleeve opening and the protruding piece is fitted inside the through hole.

The easily detachable connector of the present invention further comprising:

the protruding body further comprising a suspension arm, wherein the protruding piece is disposed on the suspension arm and the suspension arm is an elastic body;

the male connector further comprising a plurality of conduits disposing in intervals separately; and the male connector further comprising a flange for fixing the connecting position of the protruding body.

The effects of employing the easily detachable connector of the present invention lie in that: when the protruding body of the male connector is inserted inside the sleeve opening, the protruding piece of the protruding body can be fitted inside the through hole. Therefore the male connector and the female connector can be securely connected together.

### BRIEF DESCRIPTION OF THE DRAWINGS

FIG. 1 is an illustration of a conventional connector;

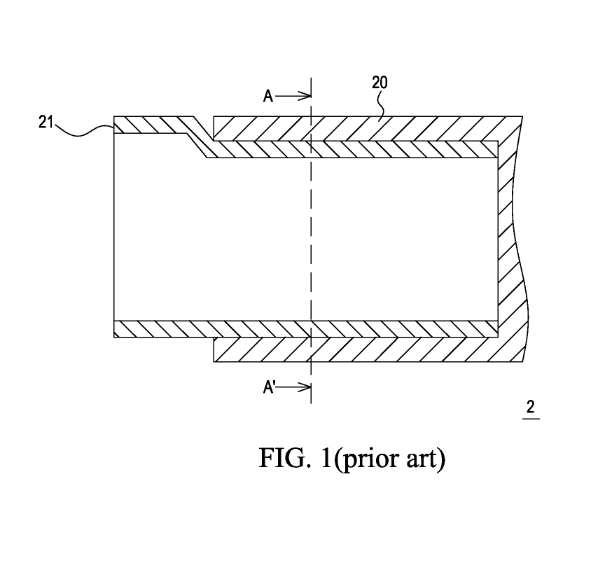

FIG. 2 is a sectional view of FIG. 1 along line A-A;

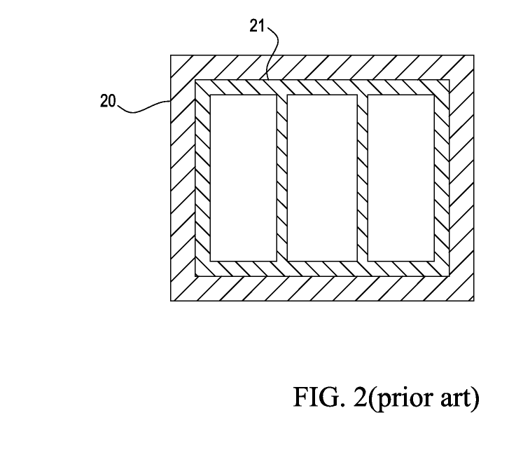

FIG. 3 is a perspective exploded view of an easily detachable connector according to an embodiment of the present invention; and

FIG. 4 is a perspective assembling view of the easily detachable connector according to an embodiment of the present invention.

### DETAILED DESCRIPTION OF THE INVENTION

Hereinafter, the preferred embodiment of the present invention will be described in detail with reference to the accompanying drawings

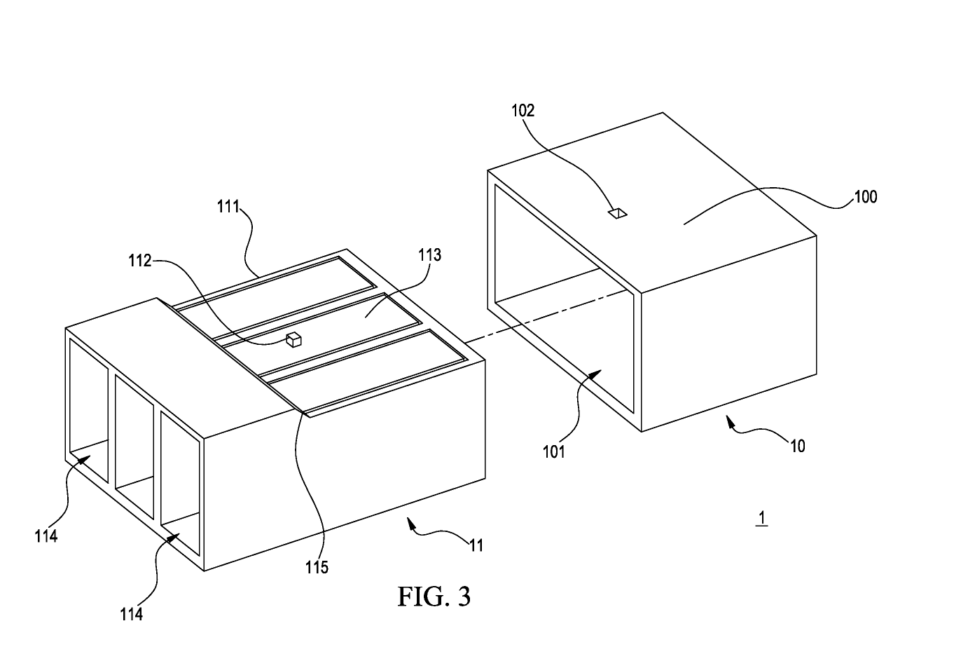

Please refer to FIG. 3, which is a perspective exploded view of an easily detachable connector according to an embodiment of the present invention.

As shown in FIG. 3, an easily detachable connector 1 comprises a female connector 10 and a male connector 11. The female connector 10 and the male connector 11 can be made of plastic materials, but they are not limited to plastic materials.

The female connector 10 has a wall body 100 and a sleeve opening 101 enclosed by the wall body 100. A through hole 102 is disposed on the wall body 100. The male connector 11 comprises a protruding body 111 corresponding to the sleeve opening 101. The protruding body 111 comprises a protruding piece 112 disposed on a position corresponding to that of the through hole 102. When the connector 1 is connected, the protruding body 111 is inserted inside the sleeve opening 101 and the protruding piece 112 is fitted inside the through hole 102.

The female connector 10 is clearance-fitted with the male connector 11. That means when the male connector 11 is inserted into the female connector 10, a clearance is disposed between an outer wall of the protruding body 111 of the male connector 11 and an inner wall of the sleeve opening 101 of the female connector 10 (which is different from the shrink fitting between the male connector 21 and the female connector 20 of the conventional connector 2).

More specifically, the protruding body 111 further comprises one or a plurality of suspension arms 113. The suspension arm 113 is an elastic body. The protruding piece 112 is disposed on the suspension arm 113. The male connector 11 further comprises a plurality of conduits 114 which are disposing in intervals independently. The conduits 114 are for wires (or electronic signal lines) to go through. For example, each of the wires can be secured in its position correctly by going through the corresponding conduit 114. Thereby, the easily detachable connector 1 can be used as a connector between wires for the transmission of the electric energy or signals of an electronic device. Furthermore, the male connector 11 further comprises a flange 115 or a slant for fixing the connecting position of the protruding body 111.

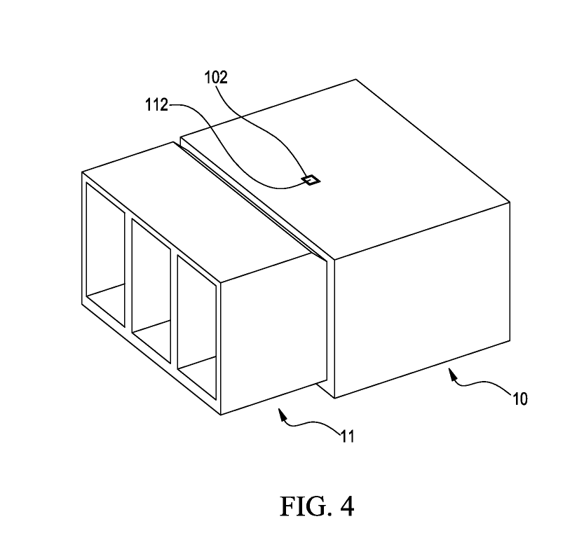

Please refer to FIGS. 3 and 4. FIG. 4 is a perspective assembling view of the easily detachable connector according to an embodiment of the present invention.

When the protruding body 111 of the male connector 11 is inserted inside the sleeve opening 101, the protruding piece 112 of the protruding body 111 can be guided and fitted inside the through hole 102 by the slightly and downwardly pressed suspension arm 113. Therefore the male connector 11 and the female connector 10 can be securely connected together. Furthermore, the wall body 100 can have two or more than two of the through holes 102 for the protruding pieces 112 of the protruding body 111 to be fitted inside the through holes 102 correspondingly. Thereby, the male connector 11 and the female connector 10 can be connected together even more securely.

As shown in the assembling status in FIG. 4, the male connector 11 can be easily detached from the sleeve opening 101 of the female connector 10 simply by pressing the protruding piece 112 on the suspension arm 113. Thereby, the male connector 11 and the female connector 10 are detached from each other as shown in FIG. 3. Therefore, regardless of the size of the easily detachable connector 1, the male connector 11 and the female connector 10 can be connected together and detached from each other easily.

As a conclusion from the above, the easily detachable connector disclosed in the embodiment of the present invention has the following advantageous effects:
1. When the protruding body of the male connector is inserted inside the sleeve opening, the protruding piece of the protruding body can be fitted inside the through hole. Therefore the male connector and the female connector can be securely connected together.
2. Different from the conventional shrink fitting, regardless of the size of the easily detachable connector disclosed in the embodiment of the present invention, the male connector and the female connector can be connected together and detached from each other easily.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An easily detachable connector comprising:
a female connector having a wall body and a sleeve opening enclosed by the wall body, wherein a through hole is formed in the wall body; and
a male connector comprising a protruding body corresponded to the sleeve opening, wherein the protruding body comprises a protruding piece disposed on a position corresponding to a position of the through hole;
when the connector being connected, the protruding body being inserted inside the sleeve opening and the protruding piece being fitted inside the through hole.

2. The easily detachable connector of claim 1, wherein the protruding body further comprises a suspension arm, the protruding piece is disposed on the suspension arm.

3. The easily detachable connector of claim 2, wherein the suspension arm is an elastic body.

4. The easily detachable connector of claim 1, wherein the male connector further comprises a plurality of conduits.

5. The easily detachable connector of claim 4, wherein the conduits are disposed in intervals separately.

6. The easily detachable connector of claim 1, wherein the male connector further comprises a flange for fixing the connecting position of the protruding body.
